(19) United States
(12) Patent Application Publication
(10) Pub. No.: US 2006/0163381 A1
(43) Pub. Date: Jul. 27, 2006

(54) Vehicle with readily demountable sprayer

(76) Inventor: Charles Balmer, Elie (CA)

Correspondence Address: ADE & COMPANY INC., P.O. BOX 28006 1795 HENDERSON HIGHWAY, WINNIPEG, MB, R2G1P0, CA

(21) Appl. No.: 11/269,890

(22) Filed: Nov. 9, 2005

Related U.S. Application Data
(60) Provisional application No. 60/626,937, filed on Nov. 12, 2004.

(51) Int. Cl. A01G 25/09; E01H 3/02; B05B 3/18; B05B 9/03

(52) U.S. Cl. 239/146; 239/172; 239/722

(57) ABSTRACT

A sprayer is readily demountable from its supporting vehicle to be replaced by another component such as a crop harvesting header or a granular spreader. The sprayer includes a common sprayer structure incorporating a tank, a boom with a plurality of spray nozzles arranged at spaced positions along the boom, a pump, and a plurality of hydraulic cylinders mounted on the common sprayer structure for effecting movement of the boom relative to the vehicle. The tank is attached to a ground engaging stand with a hydraulic lift system operable to raise the stand to a retracted position at the vehicle frame for transportation with the vehicle and to lower the stand to support the tank when demounted from the vehicle frame structure. A quick connect hydraulic coupling for a pressure line and a return line and an electrical control connection are arranged for quick connection to the vehicle by which a hydraulic control system on the sprayer can receive electrical control signals from the vehicle.

This application claims the filing date under 35 U.S.C.119 of Provisional Application Ser. No. 60/626,937 filed Nov. 12^{th} 2004.

This invention relates to a combination of a vehicle and a sprayer attachment which is readily demountable therefrom for replacement by an alternative device using the same vehicle construction.

### BACKGROUND OF THE INVENTION

In recent years attention has been given to development of high clearance agricultural vehicles for movement across the ground for transporting materials to be applied to the ground either in granular or liquid form. Developments in the types of materials to be applied have required that the vehicles be capable of movement over bare ground prior to seeding and also over the ground when the crop has emerged and yet further when the crop is well developed. These requirements have led to the development of vehicles specially arranged for these purposes which generally include relatively large ground wheels and raised axles so that the axle can pass over the top of the crop when partly or fully grown. In order to enable the vehicle to move across the ground at relatively high speed, suspension systems are necessary between the ground wheels and the axle to allow suspension movement of the ground wheels to accommodate changes in ground level. In addition it is necessary for the spacing between the ground wheels to be adjustable to allow the ground wheels to pass between the rows of a row crop and to accommodate different spacing of the row crop. These requirements have required special developments in the suspension systems and various techniques have been developed to overcome these problems associated with providing these requirements.

Sprayers of this type have generally been manufactured as dedicated machines so that the tank is an integral component of the frame structure and the boom is carried on suitable frame elements as part of the tank structure or as part of the frame structure as required. There is no intention therefore for the tank and boom to be removed from the sprayer construction since there is no intention to use the underlying vehicle frame for any other purpose.

However recently due to significant increases in cost of vehicles of this type and due to changes in economic factors, it has become desirable for machines to be convertible from transporting a tank and sprayer boom to transporting a tank for granular or particulate materials together with a metering system and spreading boom.

Such vehicles have therefore been manufactured with the tank and boom as components which can be removed from the underlying support vehicle. However this conversion has required extensive work by a relatively skilled vehicle technician to remove the fastenings, to disconnect the hydraulic couplings, to support the components when removed and to lift into place the new components.

### SUMMARY OF THE INVENTION

It is one object of the present invention to provide an improved agricultural vehicle where a sprayer assembly can be readily mounted and demounted thereon.

According to one aspect of the invention there is provided a combination comprising:

a vehicle comprising:

a vehicle frame structure for supporting elements to be transported;

a plurality of ground wheels each having a wheel hub mounted at a respective location on the frame structure for rotation of the ground wheel about the wheel hub for transporting the frame structure across the ground;

a motor;

a hydraulic pump driven by the motor;

a quick connect coupling system carried on the vehicle and arranged to provide a supply duct of hydraulic fluid under pressure from the pump and a return duct;

an electrical control system on the vehicle arranged to provide output controls;

and a sprayer assembly for mounting on the frame structure to be supported thereby in transportation across the ground, the sprayer assembly comprising:

a common sprayer structure;

a tank forming part of the common sprayer structure for containing a liquid to be sprayed, the tank having a longitudinal direction and two sides and arranged to be carried as part of the common structure on the frame structure such that the longitudinal direction is aligned along a length of the vehicle for travel of the vehicle generally along the longitudinal direction;

a boom forming part of the common sprayer structure extending to respective sides of the tank such that as the vehicle travels the boom extends to respective sides of the vehicle;

a plurality of spray nozzles arranged at spaced positions along the boom;

a pump mounted on the common sprayer structure for pumping liquid from the tank to the nozzles;

a plurality of hydraulic cylinders mounted on the common sprayer structure for effecting movement of the boom relative to the vehicle;

a ground engaging stand carried on the common sprayer structure and arranged to support the common sprayer structure from the ground;

a hydraulic lift system operable to raise the ground engaging stand from the ground to a retracted position at the vehicle frame structure for transportation of the ground engaging stand with the vehicle when spraying and operable to lower the ground engaging stand to a ground engaging position in which the common sprayer structure is supported from the ground when demounted from the vehicle frame structure;

a hydraulic control system mounted on the common sprayer structure for controlling supply of hydraulic fluid to the cylinders, the hydraulic lift system and the pump;

a quick connect hydraulic coupling for connection to the coupling system of the vehicle to provide a connection of the supply duct and the return duct to the hydraulic control system;

and an electrical control connection for quick connection to the electrical control system on the vehicle by which the hydraulic control system can receive electrical control signals from the vehicle.

Preferably the ground engaging stand includes a pair of legs spaced one on each side of the tank.

Preferably the ground engaging stand is attached to the tank at a position thereon such that, when the tank is located on the vehicle frame structure, the ground engaging stand is arranged at one end of vehicle frame structure supporting the tank cantilevered from the ground engaging stand over the vehicle frame structure.

Preferably the vehicle frame structure includes a transverse member at one end thereof and wherein the ground engaging stand is abutting or immediately adjacent the member when the tank is on the vehicle frame structure.

Preferably the ground engaging stand includes vertical legs and horizontal feet extending from the legs underneath the tank.

Preferably the boom is mounted on the common sprayer structure on the other side of the ground engaging stand from the vehicle frame structure so as to counterbalance the tank.

Preferably the tank comprises a tank wall which has no frame and is directly fastened to the ground engaging stand.

Preferably the boom is mounted on the ground engaging stand.

Preferably the vehicle frame structure includes a horizontal support plate extending substantially along the full length of the tank and the tank sits on the support plate.

Preferably the vehicle frame structure and the common sprayer structure include co-operating self centering guide members which act to locate the tank centrally of the vehicle frame structure when slightly misaligned.

In one arrangement, the self centering guide members are arranged to effect movement of the tank relative to the vehicle frame structure when the tank is lowered.

Alternatively the self centering guide members comprise front and rear guide members which lie generally in a horizontal plane and act to move the tank sideways to a center position when misaligned to one side.

Preferably the ground engaging stand can be raised by the hydraulic lift system when on the stand is on the ground to lift the tank from the vehicle frame structure.

Preferably the ground engaging stand includes a pair of vertical legs and wherein the hydraulic lift system comprises a pair of vertical cylinders each arranged at a respective leg.

Preferably the tank is attached to the vehicle frame structure by a plurality of hold downs.

Preferably the coupling system of the vehicle is arranged to release hydraulic pressure in the supply duct prior to disconnection of the quick connect hydraulic coupling from the coupling system of the vehicle.

Preferably there is provided a three way valve at the supply duct operable either to connect the supply duct to the coupling system of the vehicle for supply of hydraulic fluid under pressure to the quick connect hydraulic coupling or to release pressure to the return duct.

Preferably the tank includes a bulkhead adjacent one end defining an end section which is divided transversely into a rinse tank and a container section for the hydraulic control system.

Preferably the vehicle frame structure is constructed so as to be allowed to twist while the tank is rigid, and wherein the tank is attached to the vehicle frame structure at two points at one end and at a single pivot point ant the opposite end.

In one arrangement, the combination includes a granular spreader for location on the vehicle frame in replacement for the sprayer, the granular spreader comprising:

a common spreader structure;

a tank forming part of the common spreader structure for containing a particulate material to be spread, the tank having a longitudinal direction and two sides and arranged to be carried as part of the common structure on the frame structure such that the longitudinal direction is aligned along a length of the vehicle for travel of the vehicle generally along the longitudinal direction;

a boom forming part of the common spreader structure extending to respective sides of the tank such that as the vehicle travels the boom extends to respective sides of the vehicle;

a plurality of spreader ducts having duct discharge ends arranged at spaced positions along the boom;

a metering system mounted on the common spreader structure for metering the material from the tank to the ducts;

a plurality of hydraulic cylinders mounted on the common spreader structure for effecting movement of the boom relative to the vehicle;

a ground engaging stand carried on the common spreader structure and arranged to support the common spreader structure from the ground;

a hydraulic lift system operable to raise the ground engaging stand from the ground to a retracted position at the vehicle frame structure for transportation of the ground engaging stand with the vehicle when spreading and operable to lower the ground engaging stand to a ground engaging position in which the common spreader structure is supported from the ground when demounted from the vehicle frame structure;

a hydraulic control system mounted on the common spreader structure for controlling supply of hydraulic fluid to the cylinders, the hydraulic lift system and the metering system;

a quick connect hydraulic coupling for connection to the coupling system of the vehicle to provide a connection of the supply duct and the return duct to the hydraulic control system;

and an electrical control connection for quick connection to the electrical control system on the vehicle by which the hydraulic control system can receive electrical control signals from the vehicle.

In another arrangement, the combination includes a crop harvesting header for location on the vehicle frame in replacement for the sprayer, the crop harvesting header including mounting arms arranged for connection to the vehicle frame structure at a location thereon separate from that of the tank.

### BRIEF DESCRIPTION OF THE DRAWINGS

One embodiment of the invention will now be described in conjunction with the accompanying drawings in which:

FIG. 1 is a side elevational view of a vehicle and sprayer combination according to the present invention.

FIG. 2 is a rear elevational view of the sprayer of FIG. 1.

FIG. 3 is a rear elevational view on an enlarged scale of the sprayer of FIG. 1 with the boom removed.

FIG. 4 is a schematic illustration of the hydraulic connection between the components of the vehicle and the components on the sprayer.

FIG. 5 is a top plan view of the plate of the vehicle on which the tank of the sprayer sits.

FIGS. 6, 7 and 8 are side elevational views of a second embodiment of the present invention used on a swather type tractor

In the drawings like characters of reference indicate corresponding parts in the different figures.

### DETAILED DESCRIPTION

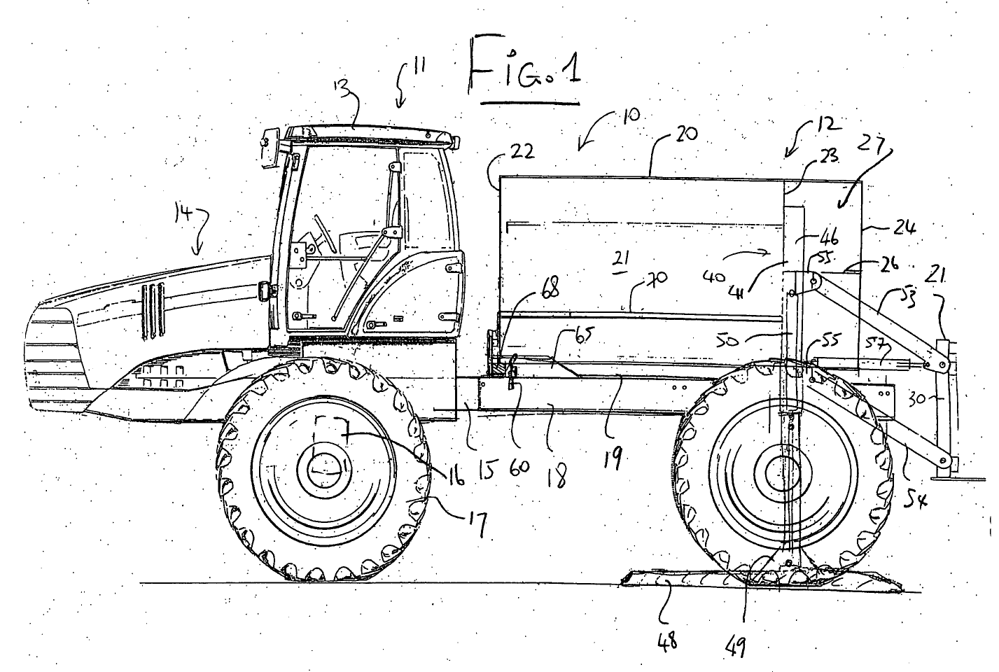

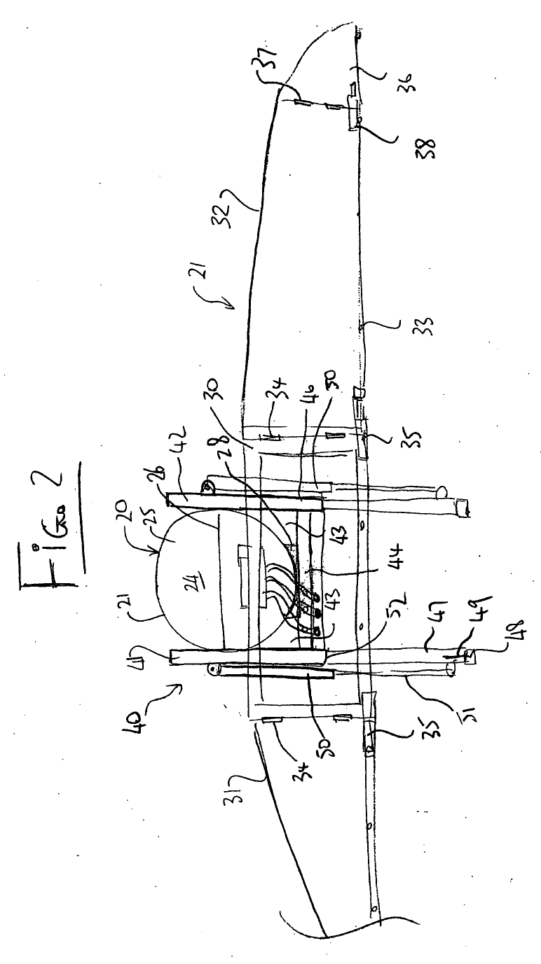

The arrangement shown in FIGS. 1 through 5 comprises a combination 10 including a vehicle 11 and sprayer assembly 12. The basic vehicle 11 includes a cab 13 and a motor 14 mounted on a frame 15 with the frame carried on axles 16 carrying front and rear ground wheels 17. The basic structure of the vehicle is shown in more detail in U.S. Pat. No. 6,406,043 of the present inventor (issued Jun. 18^{th} 2002) which discloses the details of the frame structure, the axles, the wheels and the suspension between the wheels and the axles. The disclosure set forth in this patent is incorporated herein by reference and should be referred to for any additional information concerning the structure of the vehicle which is required by the reader herein.

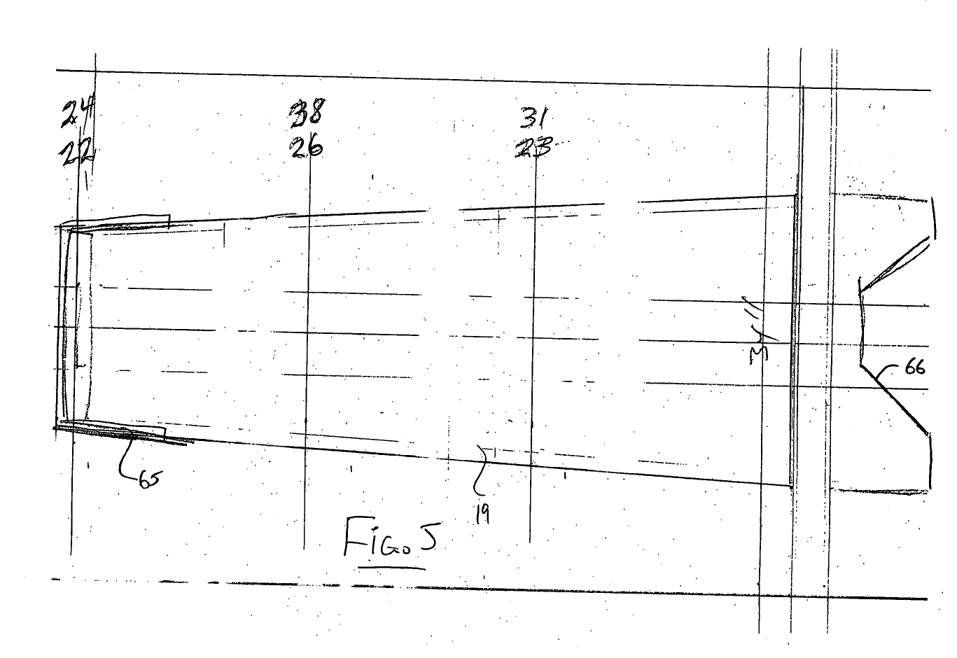

The frame 15 comprises a pair of parallel beams 18 which carry a support plate 19 the shape of which is shown in FIG. 5 which sits on top of the beams behind the cab for supporting the sprayer assembly when transported on the vehicle for spraying.

The vehicle is of the hydrostatic type so that the motor drives a hydraulic pump with the pump providing hydraulic fluid under pressure to operate the various components of the vehicle including driving wheel motors mounted at the hubs of the wheels and providing hydraulic power for the sprayer and for the various cylinders necessary for actuating movement of the components of the sprayer assembly. The sprayer assembly 12 comprises a tank 20 and a boom 21. The tank 20 is formed from a cylindrical wall 21 which is closed at a forward end by a bulkhead 22 and is closed adjacent a rear end by a second bulkhead 23 spaced from an end 24 of the cylindrical wall 21. The tank is formed without a frame so that it is structurally sound based upon the cylindrical wall and the bulkheads. At the end 24 of the cylindrical wall is provided a further bulkhead 25 which closes the top half of the cylindrical wall with a horizontal divider wall 26 separating the top half of the end compartment into a separate semi-cylindrical tank section 27. Thus a main tank section between the bulkheads 22 and 23 is formed by the cylindrical wall for containing a liquid to be sprayed. Generally the liquid is formed by a concentrate which is admixed with water within the tank so that admixture is of the required concentration for spraying by the boom 21. An agitator (not shown) can be provided within the tank to ensure proper mixing of the admixture prior to spraying. The mixing effect can be maintained subsequent to the initial mixing using the agitator by providing a return line on the spray lines so that excess liquid is returned to the tank from the nozzles as a jet within the tank thus maintaining the admixture fully admixed and at a constant ratio. Such arrangements are well known.

At the bottom of the main tank between the bulk heads 22 and 23 is provided a sump 28 which defines a flat bottom wall of the tank extending across a part of the width of the tank and extending along a part of the length of the tank so that material within the tank can be drained into the sump and extracted for emptying the tank as required.

The part cylindrical extra tank 27 provides a container of flushing water used for flushing the main tank. Thus at the end of a spraying operation when the small quantity of liquid to be sprayed remains within the tank, the small quantity can be disposed of by significantly diluting it with the flushing liquid from the extra tank 27 and then spraying the remaining liquid onto the area previously sprayed. It is not practical to double spray fully concentrated spraying liquid onto an area to be sprayed since this may damage the crop but it is possible when the small amount is heavily diluted with extra water from the tank 27 to re-spray that material onto the crop without any damage since the dilution is very low.

The boom 21 comprises a center boom section 30 and two wing boom sections 31 and 32 each of which extends out to a respective side of the tank to transport nozzles 33 at spaced positions across the width of the boom over the ground in a spraying action as is well known. The wing boom sections 31 and 32 are pivotally mounted on the center section 30 at hinge couplings 34 allowing the wing boom sections to be folded alongside the tank and therefore alongside the vehicle. Actuation of that movement is effected by hydraulic cylinders 35. The wing boom sections can also include tip sections 36 pivotal about couplings 37 and operable by hydraulic cylinders 38. The construction of the boom and the number of hydraulic actuated pivot and folding points can vary in accordance with requirements but it will be appreciated that in all cases the boom will be operable by various hydraulic cylinders to fold, raise and lower as required.

The tank 20 carries a ground engaging stand 40 which is permanently attached to the tank. The stand 40 comprises a pair of legs 41 and 42 each on a respective side of the tank. The stand is arranged adjacent the rear end 24 of the tank but is spaced forwardly from that rear end to a position adjacent the bulkhead 23. The legs 41 and 42 are straight and vertical and thus contact the cylindrical wall 21 of the tank at the tangent thereto lying in the vertical plane on each side of the tank. The legs are braced relative to the cylindrical wall 21 by gussets 43 and by a horizontal cross beam 44 underlying the bottom surface of the tank. Thus the gussets 43 are generally triangular and fill in the area between the legs and the cross member 44 with an inside edge welded to the outside surface of the cylindrical wall 21. The location of the gussets adjacent to or in the same plane as the bulkhead 23 provides a stiffening effect so that the legs are rigidly attached to the tank and provide a structure interconnection between the legs and the tank allowing the tank to be supported on the legs when separated from the vehicle;

Thus the main body of the tank 20 is located forwardly of the legs 41 and 42 with the legs defining the ground engaging stand lying in a vertical plane adjacent the rear end of the tank.

Each of the legs includes an upper outer tube 46 within which is slidable an inner tube 47. At the bottom of the inner tube 47 is located a foot 48 which is braced by gussets 49 relative to the lower end of the inner tube 47 so that each foot of the respective leg extends in a horizontal direction both forwardly underneath the tank and rearwardly to a position beyond the end of the tank. The length of the foot is determined based upon the potential tilting forces but is longer in the direction under the tank to provide sufficient length to prevent tilting of the cantilevered tank even when filled or partly filled with liquid.

The legs can be raised and lowered by cylinders 50 carried on the surface of the leg facing away from the tank. The cylinders are relatively long and extend from an upper end adjacent to but spaced downwardly from the top end of the leg to a lower end adjacent the bottom of the outer tube 46 so that the piston rod 51 extends along substantially the full length of the inner tube 47 allowing the inner tube 47 to be retracted to a position immediately adjacent the bottom end 52 of the outer tube so that the foot is drawn up to a position immediately underlying the rear axle of the frame.

The center boom section 30 is carried on the legs 41 and 42 by connection to the upper outer tube 46. This acts to transfer loads from the boom into the ground engaging stand while carrying the boom on the tank as an integral structure therewith. The center boom section is carried onto parallel links 53 and 54 which are pivotally connected to a bracket 55 on the respective leg and pivotally connected to the main vertical end beam of the center section of the boom. Thus the parallel link system 53, 54 allows the center section of the boom to be raised and lowered while maintaining the boom in a vertical plane behind the rear end 24 of the tank. Upward and downward movement is effected by cylinders 57 which extend from a coupling on the respective leg to a coupling at the outer end of the link 53.

The sprayer assembly therefore can be mounted on the vehicle by locating the bottom surface of the tank on the plate 19. When the tank is supported on the vehicle, the legs can be retracted by pulling in the cylinders 50 thus retracting the lower tube 47 to lift the foot 48 upwardly to the position underneath the frame rails 18 and underneath the axle 16 extending across between those rails. With the legs in this raised position, the sprayer assembly is carried on the vehicle and can effect spraying in a conventional manner.

When it is desired to convert the vehicle from a sprayer into another operating mode, the sprayer assembly can be removed from the vehicle quickly and simply as an integral assembly with its own supporting ground engaging stand. In order to effect removal of the sprayer assembly, the cylinders 50 are operated to lower the legs downwardly to engage the ground to a position just lifting the tank off the vehicle frame thus releasing the tank from the vehicle frame and allowing the vehicle to be driven away from the tank while the tank remains supported effectively on its stand. Thus the tank and the boom are integrally carried on the legs of the stand and can rest in a storage location until required. The location of the boom which is suspended from the rear of the legs counter balances the weight of the tank even though the boom wings may be folded forwardly along the side of the tank in this storage condition. The length of the feet is selected so that the center of gravity of the structure remains within the length of the feet regardless of the position of the boom and the amount of liquid within the tank.

The tank can be held in place on the frame during spraying by four hold down members 60 which connect between the frame and a suitable lower portion of the tank. Such hold down members are of course well known and are of the overcenter type which latch the structure in place and provide sufficient strength to prevent the tank from toppling in the event of side loads caused by tilting of the vehicle or impact upon the boom.

The interconnection between the tank and the frame includes a self centering structure which allows the tank to be moved slightly sideways in the event that the driver fails to properly align the vehicle relative to the tank when backing up the vehicle into its position underneath the tank. The self centering effect can be caused by lowering the tank from its raised position just above the vehicle into its lowered position so that the self centering effect provides a generally vertical V shape at the front and rear which co-operates with a similar shape on the bottom of the tank so that the tank is moved to fall into the V shape and hold the tank at the required transverse position relative to the vehicle as the tank is lowered.

As an alternative arrangement, the vehicle height may be adjustable by altering the pressure in the suspension system so as to bring the vehicle to a height closely matching that of the bottom surface of the tank. In this case the centering system may comprise a pair of V-shaped guides lying generally in a horizontal plane so that sliding movement of the tank toward the front of the vehicle as the vehicle moves rearwardly acts to slide the tank sideways if it is slightly misaligned. Such V-shaped guides are shown in FIG. 5 where there is a front V-shaped guide at the front of the tank as indicated at 65 and a rear V-shaped guide at the rear of the tank as indicated at 66. The rear V-shaped guide is formed in the plate 19 and a tank includes downwardly depending members 67 which engage into the rear V-shaped guide member 66 in the plate so that they project downwardly below the plate 19. At the front the V-shaped member 65 project upwardly above the plate so as to co-operate with a bottom skid member 68 attached at the front of the tank. The skid member can be formed of a suitable plastics material so as to act as a bearing sliding over the plate 19.

In the embodiment shown in FIG. 1, the rear frame section defined by the beams 18 and the cross members is rigid so as to prevent any twist of the rear section of the frame about an axis longitudinal of the vehicle. In this arrangement, therefore, the tank which is also rigid in view of its construction as set forth above can sit on a transverse line of contact at the rear and a transverse line of contact at the front without any twist interfering with the lines of contact or applying twist to the tank. However in an arrangement (not shown) where the frame is built in a manner which allows some twisting action, the tank is itself rigid and thus is attached to the rear section of the vehicle at a line contact either at the front or the rear together with a single point pivot contact at the opposite end.

The tank has on its sides a pair of horizontal platforms 70 allowing an operator to stand on the side of the tank and access the filling opening 71 at the top of the tank.

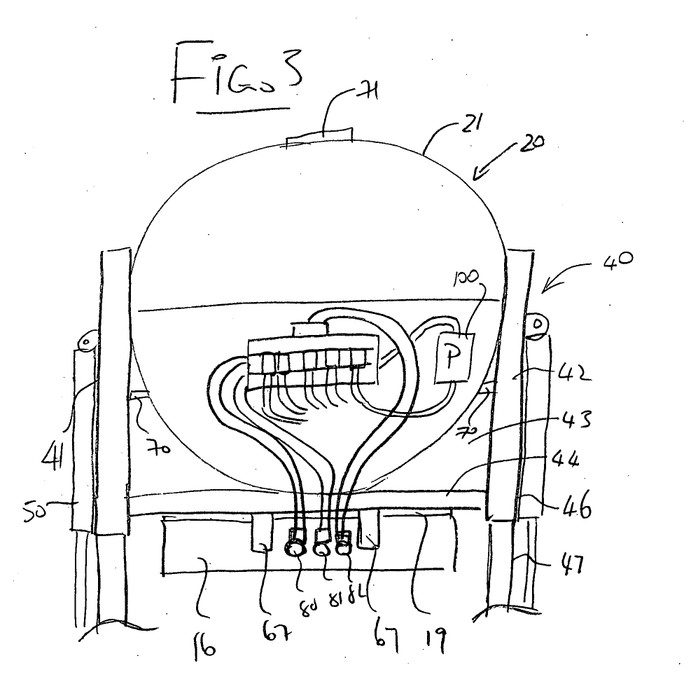

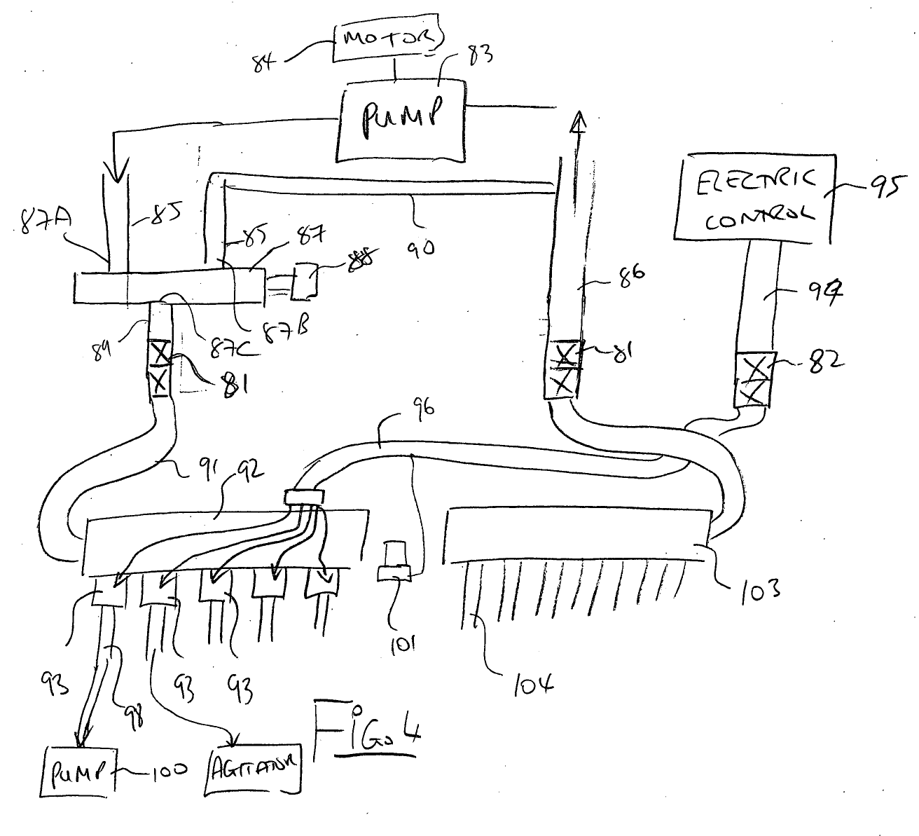

As best shown in FIGS. 3 and 4, connection between the vehicle and the sprayer assembly is limited to three couplings 80, 81 and 82. The couplings 80 and 81 are hydraulic connections using standard quick release couplings so that a fixed connector is mounted on the vehicle at the rear and a hose connector is attached to the sprayer assembly for manual quick release. The connector 82 is an electrical connection providing a number of connecting lines again of a conventional and commercially available construction.

The vehicle carries the pump indicated at 83 which is driven by the motor 84 of the vehicle. The pump generates a high pressure line 85 for supplying high pressure hydraulic fluid to the coupling 80. The pump has a return line 86 for returning low pressure fluid through the coupling 81 to a sump.

In order to allow quick release of the connector 80 while under no hydraulic pressure, there is provided a three way valve 87 which is arranged with two ports 87A and 87B on one side and one port 87C on the other side. The port 87A is connected to the pump pressure and the port 87B is connected to drain. The valve can be operated by a plunger 88 movable manually to a first position so as to direct the hydraulic fluid under pressure from the line 85 through the port 87A to the port 87C and the connected line 89, which in turn is connected to the coupling 80. The valve can be operated to a second position in which the ducts within the three way valve cause the port 87A to be disconnected from the port 87C and closed off and the port 87c to be connected to the port 87B to a drain line 90 which is directly connected to the drain line 86 of the pump. Thus when it is desired to release the coupling 80, the three way valve 87 is operated to close off the high pressure hydraulic fluid from the line 85 and to connect the line 91 to drain so that the coupling 80 is no longer under hydraulic pressure.

The coupling 80 is connected through a flexible hose 91 to a manifold 92 supplying a plurality of valves 93. The valves 93 are solenoid actuated by connections from the electrical control line 94 from a control unit 95 in the vehicle cab. Thus individual electric lines supply control power through the electrical flexible connector 96 to the solenoids 93 to operate selected ones of the valves as required to supply hydraulic fluid to the required locations. The valves 93 supply fluid to outlet lines 98 which are connected to respective ones of the pump 100 of the sprayer, to the hydraulic cylinders of the boom and to the hydraulic cylinders of the stand. An actuating switch 101 is located at the rear of the vehicle and is manually operable to effect control through the control unit 95 of the stand so that the operator located at the rear of the vehicle can operate the stand to raise and lower the tank. The hydraulic system further includes a return manifold 103 having connecting lines 104 for connection to the return of the respective components of the hydraulic system of the sprayer assembly.

Thus the spray assembly can be rapidly mounted onto the vehicle and more rapidly demounted from the vehicle simply by releasing the hold downs 60, operating the stand to raise the tank away from the vehicle and subsequently disconnecting the three connections 80, 81 and 82. When properly designed, such a construction can be mounted or demounted within a time period less than five minutes without the use of tools.

When the vehicle is backed into the sprayer assembly to mount the tank on the sprayer, the position of the stand behind the rear transverse member of the vehicle ensures that the stand is held out of the way of the vehicle as it backs in and yet the stand prevents the vehicle from backing too far and causing the tank to engage the cab since the stand is located at or immediately adjacent the rear transverse member in the form of the axle.

In the embodiment of FIGS. 1 through 5, the spray assembly can be replaced by a spreader assembly of a similar construction including a tank and a boom and a ground engaging stand substantially identical to those of FIG. 1. The boom however is modified so that it is of a type including a plurality of ducts and a tank includes a metering system which discharges particulate material from the tank into the ducts. A suitable arrangement is disclosed in U.S. Pat. No. 5,052,627 issued Oct. 1^{st} 1991 of the present inventor, the disclosure of which is incorporated herein by reference.

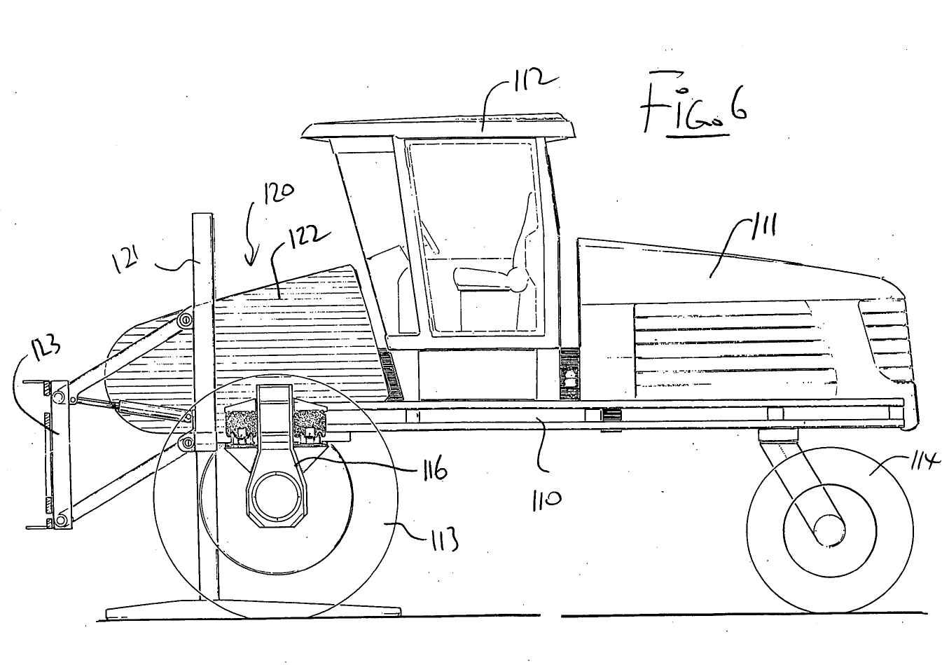

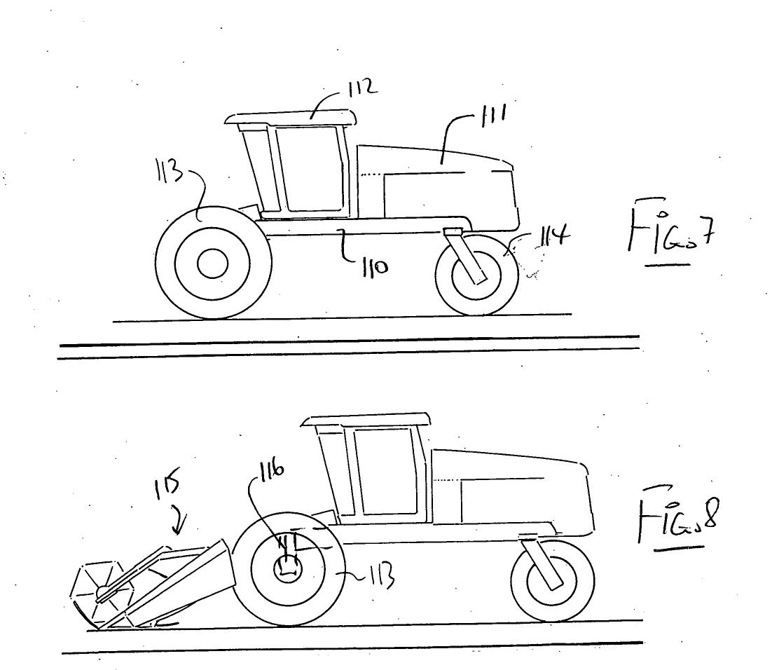

Turning now to FIGS. 6 through 8, a modified arrangement is shown utilizing the construction as previously described in which the vehicle is of a type suitable for mounting a header for use as a swather. Thus in FIG. 7 the vehicle is shown including a frame 110, a motor and pump 111 and a cab 112. In this type of arrangement the front wheels 113 are driven and the rear wheels are free wheeling castor wheels as indicated at 114. In this arrangement the header 115 is carried on the front legs 116 carrying the front wheels 113 as indicated in FIG. 8. The header is readily removable from the legs 116 in conventional manner and is replaced by a sprayer assembly 120 as shown in FIG. 6. The spray assembly 120 includes the ground engaging frame 121, a tank 122 and a boom 123 substantially as previously described. The tank is shaped so that it fits on the front of the frame in front of the cab 112. In this arrangement the tank may include a pair of insert tubes which slide into the tubular members forming the frame 110 thus holding the tank in place without the necessity for hold downs. Tractors of this type are well known to provide accurate movement and hence the sliding of tube one inside the other to provide a support for the tank is viable in view of the accurate movement which can be achieved to ensure that the tube slide one inside the other accurately. The vehicle is modified relative to a conventional swather tractor by moving the cab rearwardly so that the tank is located on the frame over the front axle. Conventionally the cab is mounted over the front axle thus requiring a tank to be mounted in front of the front axle but this is undesirable in view of improper weight balances.

Since various modifications can be made in my invention as herein above described, and many apparently widely different embodiments of same made within the spirit and scope of the claims without departing from such spirit and scope, it is intended that all matter contained in the accompanying specification shall be interpreted as illustrative only and not in a limiting sense.

1. A combination comprising:
a vehicle comprising:
a vehicle frame structure for supporting elements to be transported;
a plurality of ground wheels each having a wheel hub mounted at a respective location on the frame structure for rotation of the ground wheel about the wheel hub for transporting the frame structure across the ground;
a motor;
a hydraulic pump driven by the motor;
a quick connect coupling system carried on the vehicle and arranged to provide a supply duct of hydraulic fluid under pressure from the pump and a return duct;
an electrical control system on the vehicle arranged to provide output controls;
and a sprayer assembly for mounting on the frame structure to be supported thereby in transportation across the ground, the sprayer assembly comprising:
a common sprayer structure;
a tank forming part of the common sprayer structure for containing a liquid to be sprayed, the tank having a longitudinal direction and two sides and arranged to be carried as part of the common structure on the frame structure such that the longitudinal direction is aligned along a length of the vehicle for travel of the vehicle generally along the longitudinal direction;
a boom forming part of the common sprayer structure extending to respective sides of the tank such that as the vehicle travels the boom extends to respective sides of the vehicle;
a plurality of spray nozzles arranged at spaced positions along the boom;
a pump mounted on the common sprayer structure for pumping liquid from the tank to the nozzles;
a plurality of hydraulic cylinders mounted on the common sprayer structure for effecting movement of the boom relative to the vehicle;
a ground engaging stand carried on the common sprayer structure and arranged to support the common sprayer structure from the ground;
a hydraulic lift system operable to raise the ground engaging stand from the ground to a retracted position at the vehicle frame structure for transportation of the ground engaging stand with the vehicle when spraying and operable to lower the ground engaging stand to a ground engaging position in which the common sprayer structure is supported from the ground when demounted from the vehicle frame structure;
a hydraulic control system mounted on the common sprayer structure for controlling supply of hydraulic fluid to the cylinders, the hydraulic lift system and the pump;
a quick connect hydraulic coupling for connection to the coupling system of the vehicle to provide a connection of the supply duct and the return duct to the hydraulic control system;
and an electrical control connection for quick connection to the electrical control system on the vehicle by which the hydraulic control system can receive electrical control signals from the vehicle.

2. The combination according to claim 1 wherein the ground engaging stand includes a pair of legs spaced one on each side of the tank.

3. The combination according to claim 1 wherein the ground engaging stand is attached to the tank at a position thereon such that, when the tank is located on the vehicle frame structure, the ground engaging stand is arranged at one end of vehicle frame structure supporting the tank cantilevered from the ground engaging stand over the vehicle frame structure.

4. The combination according to claim 1 wherein the vehicle frame structure includes a transverse member at one end thereof and wherein the ground engaging stand is abutting or immediately adjacent the member when the tank is on the vehicle frame structure.

5. The combination according to claim 1 wherein the ground engaging stand includes vertical legs and horizontal feet extending from the legs underneath the tank.

6. The combination according to claim 1 wherein the boom is mounted on the common sprayer structure on the other side of the ground engaging stand from the vehicle frame structure so as to counterbalance the tank.

7. The combination according to claim 1 wherein the tank comprises a tank wall which has no frame and is directly fastened to the ground engaging stand.

8. The combination according to claim 7 wherein the boom is mounted on the ground engaging stand.

9. The combination according to claim 1 wherein the vehicle frame structure includes a horizontal support plate extending substantially along the full length of the tank and the tank sits on the support plate.

10. The combination according to claim 1 wherein the vehicle frame structure and the common sprayer structure include cooperating self centering guide members which act to locate the tank centrally of the vehicle frame structure when slightly misaligned.

11. The combination according to claim 10 wherein the self centering guide members are arranged to effect movement of the tank relative to the vehicle frame structure when the tank is lowered.

12. The combination according to claim 10 wherein the self centering guide members comprise front and rear guide members which lie generally in a horizontal plane and act to move the tank sideways to a center position when misaligned to one side.

13. The combination according to claim 1 wherein the ground engaging stand can be raised by the hydraulic lift system when on the stand is on the ground to lift the tank from the vehicle frame structure.

14. The combination according to claim 1 wherein the ground engaging stand includes a pair of vertical legs and wherein the hydraulic lift system comprises a pair of vertical cylinders each arranged at a respective leg.

15. The combination according to claim 1 wherein the tank is attached to the vehicle frame structure by a plurality of hold downs.

16. The combination according to claim 1 wherein the coupling system of the vehicle is arranged to release hydraulic pressure in the supply duct prior to disconnection of the quick connect hydraulic coupling from the coupling system of the vehicle.

17. The combination according to claim 16 wherein there is provided a three way valve at the supply duct operable either to connect the supply duct to the coupling system of the vehicle for supply of hydraulic fluid under pressure to the quick connect hydraulic coupling or to release pressure to the return duct.

18. The combination according to claim 1 wherein the tank includes a bulkhead adjacent one end defining an end section which is divided transversely into a rinse tank and a container section for the hydraulic control system.

19. The combination according to claim 1 wherein the vehicle frame structure is constructed so as to be allowed to twist while the tank is rigid, and wherein the tank is attached to the vehicle frame structure at two points at one end and at a single pivot point ant the opposite end.

20. The combination according to claim 1 wherein the combination includes a granular spreader for location on the vehicle frame in replacement for the sprayer, the granular spreader comprising:
a common spreader structure;
a tank forming part of the common spreader structure for containing a particulate material to be spread, the tank having a longitudinal direction and two sides and arranged to be carried as part of the common structure on the frame structure such that the longitudinal direction is aligned along a length of the vehicle for travel of the vehicle generally along the longitudinal direction;
a boom forming part of the common spreader structure extending to respective sides of the tank such that as the vehicle travels the boom extends to respective sides of the vehicle;
a plurality of spreader ducts having duct discharge ends arranged at spaced positions along the boom;
a metering system mounted on the common spreader structure for metering the material from the tank to the ducts;
a plurality of hydraulic cylinders mounted on the common spreader structure for effecting movement of the boom relative to the vehicle;
a ground engaging stand carried on the common spreader structure and arranged to support the common spreader structure from the ground;
a hydraulic lift system operable to raise the ground engaging stand from the ground to a retracted position at the vehicle frame structure for transportation of the ground engaging stand with the vehicle when spreading and operable to lower the ground engaging stand to a ground engaging position in which the common spreader structure is supported from the ground when demounted from the vehicle frame structure;
a hydraulic control system mounted on the common spreader structure for controlling supply of hydraulic fluid to the cylinders, the hydraulic lift system and the metering system;
a quick connect hydraulic coupling for connection to the coupling system of the vehicle to provide a connection of the supply duct and the return duct to the hydraulic control system;
and an electrical control connection for quick connection to the electrical control system on the vehicle by which the hydraulic control system can receive electrical control signals from the vehicle.

21. The combination according to claim 1 wherein the combination includes a crop harvesting header for location on the vehicle frame in replacement for the sprayer, the crop harvesting header including mounting arms arranged for connection to the vehicle frame structure at a location thereon separate from that of the tank.
